(19) United States
(12) Patent Application Publication
(10) Pub. No.: US 2011/0308709 A1
(43) Pub. Date: Dec. 22, 2011

(54) MANDREL WITH INTEGRAL HEAT PIPE

(76) Inventor: Joseph Ouellette, Tecumseh (CA)

(21) Appl. No.: 13/139,029

(22) PCT Filed: Dec. 10, 2009
(86) PCT No.: PCT/CA09/01816

§ 371 Date: Jul. 27, 2011

Related U.S. Application Data
(60) Provisional application No. 61/121,952, filed on Dec. 12, 2008.
(60) Provisional application No. 61/232,822, filed on Aug. 11, 2009.
(60) Provisional application No. 61/237,328, filed on Aug. 27, 2009.

(51) Int. Cl. B65H 81/06; B28B 21/52; D01D 5/00

(52) U.S. Cl. 156/172; 264/209.6; 425/90; 156/499

(57) ABSTRACT

A mandrel having an integral heat pipe is employed in the manufacture of filament wound pipe segments and vessels to provide even heating of the interior of the pipe or vessel during the heating and curing process. Heating or cooling can be provided using the thermal transfer characteristics of the heat pipe.

### RELATED APPLICATIONS

This application claims priority to U.S. Ser. No. 61/237,328 U.S. Ser. No. 61/232,822, and U.S. Ser. No. 61/121,952, the contents all of which are hereby incorporated by reference in their entirety.

### FIELD OF THE INVENTION

The field of the invention generally relates to the use of heating elements and their use in the manufacture of composite components.

### BACKGROUND OF THE INVENTION

Filament wound composite pipe segments and composite vessels are used in a variety of fields due to their beneficial properties, including their strength and light weight. In manufacture, a mandrel is employed as a form around which a filament is wound. The filament is often a fiber reinforced plastic. After winding the filament around the mandrel, and obtaining a suitable thickness and length for the segment or vessel, the resulting work piece is heated in an oven to cure. During heating, resin changes phase from liquid to solid. In this process, the resin encapsulates the filament, thereby containing it in its wound orientation, and holding it in the same orientation as the resin hardens. Heating can also activate curing agents in the filament. The work piece is heated for a predetermined amount of time and is then removed from the oven to allow the curing process to continue. Additional cure time may be at ambient temperature, or may require placement of the mandrel and winding in another oven at a different temperature for a period of time.

A conventional hollow mandrel will permit only a limited degree of heating from the centre of the work piece when placed in a convection curing oven. Solid or sealed mandrels provide even less heat to the center of the work piece than a hollow mandrel. Uneven curing of the work piece may result.

Upon completion of the heating cycle, the work piece can be removed from the heat source and allowed to cool down and continue the curing process. This can be a slow process as the mandrel itself retains residual heat from the convection oven, and as a result continues to heat the inner surface of the pipe segment

There remains a need for improved manufacture of composite pipe segments and composite vessels.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

In accordance with one aspect of the present invention there is provided a method of making a composite article using a resin-impregnated filamentary material, comprising the steps of: providing a mandrel with integral heat pipe; applying said uncured composite material to the outer surface of said mandrel; and curing said resin-impregnated filamentary material applied to said mandrel so as to form said article, wherein said curing comprises heating a portion of the outer surface of said mandrel with integral heat pipe.

In another aspect of the present invention there is provided a method of making a pressure vessel using a resin-impregnated filamentary material and a metallic liner, comprising: providing a mandrel with integral heat pipe, said mandrel comprising a first end for removable attachment to a filament winding machine, a second end sized for insertion through an opening of said liner within an inner volume of said liner, and securing means positioned between said first and second end configured for releasable attachment of said opening in said liner to said mandrel with integral heat pipe; attaching said liner to said mandrel with securing means such that said second end of said mandrel is disposed though said opening of said liner in said inner volume of said liner, the outer surface of said second end of said mandrel being in heat transfer relation with the inner surface of said liner; applying said uncured filamentary material to said liner by rotating said mandrel about an axis of said mandrel while applying said filamentary material around the outer surface of said liner; and curing said resin-impregnated filamentary material applied to said mandrel so as to form said pressure vessel, wherein curing comprises heating a portion of said outer surface of said mandrel with integral heat pipe to transfer heat to the inner surface of said liner.

In another aspect of the present invention there is provided a method of making a pressure vessel using a resin-impregnated filamentary material and a non-metallic liner, comprising: providing a support defining a passage there through, said support comprising a first end for removable attachment to a filament winding machine, a second end comprising securing means for removable attachment to an opening on said liner and having a ball valve positioned within said passage at said second end; attaching said liner to said second end of said support mandrel with said securing means, said passage being in fluid communication with an interior volume of said liner; providing a heat transfer fluid and a metallic material to said interior volume of said liner, said heat transfer fluid and said metallic material being in heat transfer relation with the inner surface of said liner; applying said uncured filamentary material to said liner by rotating said mandrel about an axis of said mandrel while applying said filamentary material around the outer surface of said liner; and curing said resin-impregnated filamentary material so as to form said pressure vessel, wherein said curing comprises heating said metallic material within said interior volume of said liner so as to produce heated metallic material within said heat transfer fluid so as to transfer heat to the inner surface of said liner.

In accordance with another aspect of the present invention there is provided a method of extruding a thermoplastic feed stock, comprising the steps of: providing an extruder with integral heatpipe comprising an input end and an output end; introducing said thermoplastic feed stock to said input end; heating a portion of the outer surface of said extruder with integral heat pipe such that said feedstock is plastic and homogeneous; conveying said plastic feedstock from said input end to said output end; and providing said plastic feedstock to output means.

In accordance with another aspect of the present invention there is provided a method of making a composite article using a resin-impregnated filamentary material, comprising the steps of: providing a mandrel with integral heat pipe in a first position; applying said uncured composite material to the outer surface of said mandrel; and curing said resin-impregnated filamentary material applied to said mandrel so as to form said article, wherein said curing comprises heating said outer surface of said mandrel with integral heat pipe; cooling said cured resin-impregnated filamentary material on said mandrel with integral heat pipe in a second position; removing said cooled cured resin-impregnated filamentary material from said mandrel with integral heat pipe in a third position.

In another aspect of the present invention there is provided a mandrel with integral heat pipe, comprising: a heat pipe or thermosyphon comprising a first end, a second end and end caps attached to said first and second end, said heat pipe defining an inner volume; a tubular member disposed within said inner volume of said heat pipe, said member comprising a fluid inlet, a flow path, a fluid outlet, and expansion means positioned between said fluid inlet and said fluid outlet, said fluid inlet adapted for connection to a source of liquid, said fluid outlet adapted for connection to an outlet.

In another aspect of the present invention there is provided a method of making a vessel using a resin-impregnated filamentary material and a liner, comprising: providing a mandrel with integral heat pipe, said mandrel comprising a first end for removable attachment to a filament winding machine, a second end sized for insertion through an opening of said liner within an inner volume of said liner, and securing means positioned between said first and second end configured for releasable attachment of said opening in said liner to said mandrel with integral heat pipe; providing a metallic material to said interior volume of said liner, said metallic material being in heat transfer relation with the inner surface of said liner; attaching said liner to said mandrel with securing means such that said second end of said mandrel is disposed though said opening of said liner in said inner volume of said liner; applying said uncured filamentary material to said liner by rotating said mandrel with integral heat pipe about an axis of said mandrel while applying said filamentary material around the outer surface of said liner; and curing said resin-impregnated filamentary material so as to form said pressure vessel, wherein said curing comprises heating said metallic material within said interior volume of said liner so as to produce heated metallic material so as to transfer heat to the inner surface of said liner.

In another aspect of the present invention there is provided an extruder with integral heat pipe, comprising: a tubular member comprising a heat pipe or thermosyphon, a first and a second end configured for attachment to rotation means, and a helical flight disposed along the length of the outer surface of said tubular member.

### BRIEF DESCRIPTION OF THE DRAWINGS

Embodiments of the present invention will now be described, by way of example only, with reference to the attached Figures, wherein:

FIG. 1 illustrates one embodiment of a mandrel with integral heat pipe of the present invention;

FIG. 2 (Panel A) is cross section diagram showing another embodiment of the present invention of a mandrel with integral thermosyphon, (Panels B and C) are end views of the mandrel with integral thermosyphon shown in Panel A;

FIG. 3 illustrates cross section views of (Panel A and B) a mandrel with integral heat pipe and (Panel C) a cross section view of taken along A-A;

FIG. 4 illustrates (Panel A) a side view and (Panel B) an end view of an extruder with integral heat pipe;

FIG. 5 illustrates a (Panel A) cross sectional view of an additional embodiment of the present invention and (Panel B) an end view of Panel A;

FIG. 6 illustrates a cross section view of a alternate embodiment of a mandrel with integral heat pipe of the present invention;

FIG. 7 illustrates a (Panel A) cross sectional view of an additional embodiment of the present invention and (Panel B) an end view of Panel A; and

FIG. 8 illustrates another embodiment of the mandrel with integral heat pipe of the present invention.

In the detailed description that follows, the numbers in bold face type serve to identify the component parts that are described and referred to in relation to the drawings depicting various embodiment of the invention. It should be noted that in describing various embodiments of the present invention, the same reference numerals have been used to identify the same of similar elements. Moreover, for the sake of simplicity, parts have been omitted from some figures of the drawings.

### DETAILED DESCRIPTION

One embodiment of the present invention is directed to a mandrel with integral heat pipe and uses thereof.

One aspect of the present invention describes a modification of a typical filament winding mandrel which is achieved by adapting or fabricating a mandrel to be a mandrel with integral heat pipe or mandrel with integral thermosyphon. By making this modification or fabrication, the mandrel with integral heat pipe or integral thermosyphon (both are generally referred to as mandrel with integral heat pipe, herein) achieves the ability to absorb thermal energy from a localized area(s) on its surface and redistributes that energy rapidly to achieve a uniform or near isothermal temperature condition on the entire useable outer surface of the mandrel.

One skilled in the art will appreciate that where reference has been made to the heat pipe being integral, this reference is made from a functional perspective. A mandrel is often a sealed element, in which case a heat pipe can be integrally incorporated in the mandrel. However, where the mandrel is not a sealed element, a heat pipe can be removably inserted into the mandrel. When inserted into the mandrel (using the mandrel as a sleeve), it is understood that the isothermal properties of the heat pipe may not be fully provided to the exterior surface of the mandrel due to a number of manufacturing issues, including the inability to ensure a perfect fit that would aid in the thermal transfer process. A sleeved heat pipe will still provide near isothermal functionality to the mandrel and will provide many of the benefits of the present invention (though they may be somewhat diminished in embodiments not making use of high precision tolerances).

Filament Winding

Filament wound composite pipe segments and composite vessels are commonly used in a variety of fields due to their beneficial properties, including their strength and light weight. In manufacture, a mandrel is employed as a form around which a filament is wound.

It will be clear that pipe, tube or other hollow sections of various geometries, such as ovoid, square, rectangular etc., with parallel sides or having a draft, may be used. Vessels with one open end are may also be used. Vessels with more than one open end may be also be used. Some mandrels may incorporate these shapes and produce components, also referred to as work pieces, which are closed at one end.

In a filament winding process, typically, a band of continuous resin impregnated rovings or monofilaments (referred to as filamentary material) is wrapped around a rotating mandrel and then cured to produce the final product. It will be appreciated that a mandrel can be rotated relative to the filament being wound, or vice versa.

Mandrel(s)

A Mandrel used in the filament winding process are known to the skilled worker, and are typically made of Drawn Over Mandrel (DOM) steel tubing. However, other materials such as aluminum are also used. Such mandrels are hollow and are machined at both ends to permit positive attachment to multiple jaw chucks and live centers used in the winding machines to orient the mandrel to the center of the machine and to permit turning the mandrel while winding the resin fibre matrix.

For example, a mandrel is a hollow cylinder made of steel. The ends of the mandrel are welded sections of hexagonal steel bar used to grip the mandrel by its ends in the chucks of the winding machine. As noted above, the steel tube used for the mandrel is typically DOM tubing. The end sections are typically welded on to the tube section. The tube sections are centerless ground and plated as required by the processor.

During curing of a work piece, the hollow mandrel with the resin fiber matrix wound around it is placed in a cure oven, usually operating at an elevated temperature of approximately 350 F for a number of hours until the resin is crosslinked and cured creating a solid resin/fiber structure, or work piece. Following curing, the mandrel is removed (e.g., pulled or pushed) from the work piece, and the mandrel can be reused to form the next work piece.

The economic value of the process is, in part, predicated on the time in which the process completes and the quality of the resultant part. The resin requires heat in order to catalyze and cure. The source of heat is typically the cure oven in which the mandrel and work piece are placed. Because the uncured resin/fiber matrix is thermally insulative in nature, and because the mandrel (whether hollow or solid) is not heated directly, the mandrel is heated last while in the oven. Thus, energy from the cure oven heats the resin/fiber matrix from the exterior surface of the work piece to the interior of the work piece.

The skilled worker will appreciate that resin tends to become substantially less viscous as it approaches the glass transition or cure temperature. Low viscosity allows the resin to wet out and flow between the fibres as it heats. As noted above, the heat applied to the resin fibre matrix in traditional mandrel applications is from the outer diameter (O.D.) of the uncured matrix work piece, to the inner surface. Resin tends to flow towards the heated outer surface and away from the inner surface contiguous with the mandrel surface. This can, potentially, result in areas of porosity, unwetted fibre and micro cracking in this region.

Because the resin fibre matrix of the work piece acts as an insulator, it can take a significant amount time in the oven to achieve a cured temperature on the inner surface of the matrix. The oven temperature must be controlled so as not to exceed the maximum process temperature of the resin used in the process.

Heat Pipes and Thermosyphons

One skilled in the art will appreciate that heat pipes and thermosyphons are known technical elements.

A heat pipe is a sealed element that has a fluid in a partial vacuum, and preferably includes a wick. As heat is applied to any portion of the heat pipe, the liquid in that area is converted to a gas. This phase change absorbs thermal energy. The vapour is transferred through the heat pipe and in cooler portions of the pipe it condenses in a phase change that releases the absorbed thermal energy. In this fashion a heat pipe will transfer heat from one area to another.

In the present invention, a heat pipe can either be used as a mandrel, or can be embedded in a conventional mandrel (both referred to herein as a mandrel with integral heat pipe). Such a mandrel with integral heat pipe is used in the manufacturing of filament wound components.

After winding the uncured filament around the outer surface of the mandrel with integral heat pipe, the work piece produced can be introduced to a heated environment. The exposed sections of the of the mandrel with integral heat pipe absorb the heat of the heat source. In one example, the heat provided is the ambient heat of an oven, which heat is transferred to the other regions of the heat pipe. The efficient temperature equalization properties of a heat pipe results in the interior surface of the filament wound work piece being heated to the same temperature as the exterior of the filament wound work piece.

During the cooling phase, the mandrel with integral heat pipe provides further functionality. It may be desirable to continue heating the interior of the pipe segment while the exterior is allowed to slowly cool. This is accomplished by heating one end of the heat pipe after the work piece has been removed from the oven. The heat pipe will continue to provide heat to the interior of the work piece.

Additionally, it will be appreciated that epoxy filament matrices may create exotherms during the cure process. These exotherms may not be general, but rather localized in nature. The mandrel with integral hear pipe has the capability of redistributing these exothermic energy spikes throughout the mandrel surface. Thus, the mandrel with integral heat pipe also reduces the potential for localized thermal spikes which can cause delamination and vaporization due to excessive heat.

In an alternate example, after being removed from the oven, an end of the heat pipe can be cooled. This will serve to draw heat away from the work piece and promote a faster cool down cycle.

One skilled in the art will appreciate that there are similarities in the manner in which heat pipes and thermosyphons work. The mandrel described above can be modified to make use of a thermosyphon, as will be understood by those skilled in the art, without departing from the scope of the present invention. Both the mandrel with integral heat pipe and mandrel with integral thermosyphon are generally referred to as a mandrel with integral heat pipe herein.

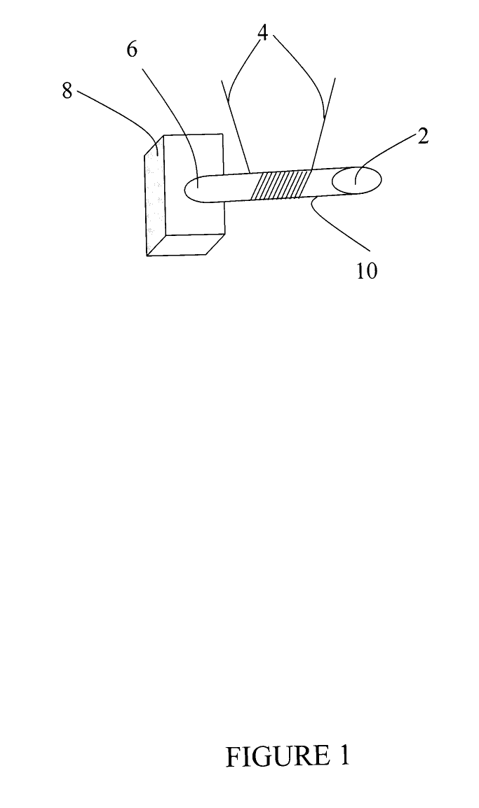

FIG. 1 illustrates an embodiment of the present invention in which uncured epoxy impregnated filament 4 is applied using a winding machine (not shown) to mandrel with integral heat pipe 2, by winding uncured epoxy impregnated filament 4 around outer surface 10. Mandrel with integral heat pipe 2 is rotated about its longitudinal axis during application of uncured epoxy impregnated filament 4. It will be appreciated that the mandrel with integral heat pipe can be stationary during filament application, with the filament being around the outer surface of the mandrel with integral heat pipe.

FIG. 1 depicts first end 6 of mandrel with integral heat pipe 2 inserted into heating/cooling control unit 8 that allows outer surface 10 of mandrel with integral heat pipe 2 to be heated or cooled according to a predetermined path.

In one example, mandrel with integral heat pipe 2 is a heat pipe of thermosyphon.

In one example, mandrel with integral heat pipe 2 is a mandrel modified to function as a heat pipe or thermosyphon.

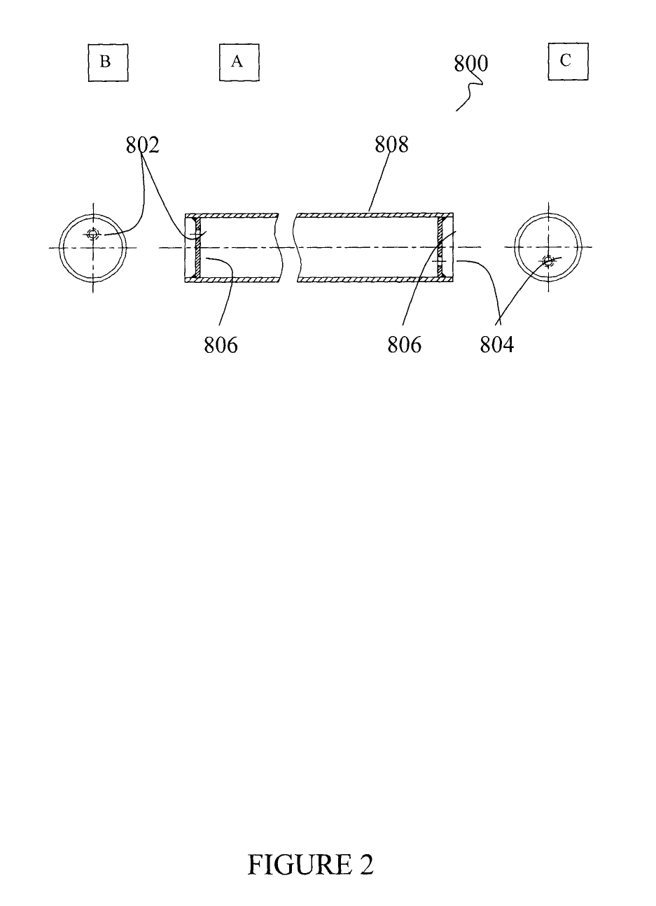

FIG. 2 depicts a cross sectional view of an example in which mandrel with integral heat pipe 800 is constructed such that end caps 802 are welded with a pressure tight weld to the ends of the mandrel 808. The wall stock of mandrel 808 and the structure of mandrel 808 is configured to be a pressure vessel, capable of maintaining the pressures associated with the heat pipe or thermosyphon at operating temperature (and therefore the pressure of its required processing temperature). Threaded port 802 is provided at one end of mandrel 808 in end cap 802 for the installation of a fitting for evacuation, fluid charging and sealing. Threaded port 804 at the other end of mandrel 808 is provided for the installation of a safety overpressure fail safe rupture disc.

In one example, in the case of a mandrel with thermosyphon, the fluid charge within the thermosyphon is about 30% of the volume of the thermosyphon. In use, in this example, the mandrel with thermosyphon is rotated at low RPM during application of the uncured epoxy impregnated filamentous material.

### Induction Heating

In another embodiment of the present invention, induction heating is used to heat the outer surface of the mandrel with integral heat pipe.

In this example, an induction heater is used to heat a region of the mandrel with integral heat pipe. Heating of the mandrel with integral heat pipe by the induction coil causes the outer surface of the mandrel with integral heat pipe to become substantially uniform in surface temperature. The localized energy is redistributed uniformly throughout the mandrel due to the energy transfer typical of a heat pipe or thermosyphon. This energy on the surface of the mandrel is transmitted to the filament resin winding, thereby causing it to cure uniformly from the interior surface of the work piece.

A skilled worker will appreciate that the specific configuration of the induction coil and parameters used (e.g., operating frequency, coupling distance, power, and the like) will vary according to the application, needs and preferences of the intended use. Additionally, selection of the specific components used may be based on various additional criteria, including for example, but not limited to, cost, availability, downstream application, and safety.

In one example, the induction coil is commercially available.

In another example, the induction coil is potted in epoxy, or other resin(s), to protect the coils from damage and/or contamination in the process.

In another specific example, the induction coil is configured as a complete diameter coil.

In another specific example, the induction coil is “C” shaped, and concentrates the output of the induction coil within the “C” of the induction coil. In this example, the out put from the “C” shaped coil radiates on to a lower half of the mandrel.

Heat is applied to the mandrel with integral heat pipe either during application of uncured filament or subsequent to application of uncured filament.

In one example, the induction coil permits uncured filaments and resin to be wound around the mandrel with integral heat pipe and subjected to uniform heat while the winding is occurring, thus beginning the cure process during the winding phase of the process, if desired.

Typically, the output from the induction power supply is typically controlled via the output from a process controller and characterized by proportional band, integral and derivative. The process controller is provided with process temperature data inputs from an infrared sensor which monitors the temperature of the mandrel with integral heat pipe surface directly, and outputs a signal to the process controller

It will be appreciated that an infrared temperature sensor is one example of a suitable temperature sensor. Various non-contact temperature sensor or contact temperature sensors may be used.

In use, the thermal energy is applied to a portion of the metal surface of the mandrel with integral heat pipe by the induction coil. The thermal energy is applied in the presence or absence of the resin and filament windings in place.

In one example, the filaments used in the production of the work piece are substantially refractory to inductive heating and so energy from the induction coil will not be “sensed” directly by the resin and filament because they are not metallic. When the energy from the induction coil becomes thermal rather than RF (resonant frequency) as it is absorbed by the metal surface of the mandrel with integral heat pipe, the thermal energy transfer along mandrel with integral heat pipe is typical of a heat pipe or thermosyphon, which redistributes the thermal energy uniformly throughout the mandrel.

In another example, filaments used in the production of the work piece include conductive material such as carbon fiber, and will heat up when excited by RF of the induction coil. Further, filaments which may have metallic strands embedded within them and may also heat up if directly presented with induced RF energy.

In the case of filament that include heat conductive material, the work piece can be cured by positioning the coil adjacent to a portion of the mandrel with integral heat pipe that is exposed, and not covered by the filament and not within the output range of the induction coil.

In one example of the present invention, a mandrel with integral heat pipe is fabricated. In this example, a typical (i.e. non-heat pipe) mandrel is evacuated, charged and sealed, thereby causing it to become a heat pipe or thermosyphon (referred to as a mandrel with integral heat pipe, herein). The mandrel with integral heat pipe is mounted on a winding machine. A heat induction coil surrounds a localized area of the mandrel with integral heat pipe. The induction coil is attached to an RF generator or induction power supply typically used for noncontact heating of metallic components. The mandrel is free to rotate within the induction coil. The induction coil generates a power rated in kilowatts on the mandrel at the local surface area beneath the coil. Because the mandrel is operationally a heat pipe or thermosyphon, the energy provided to the local area of the mandrel with integral heat pipe by the induction coil is distributed throughout the entire interior volume of the mandrel with integral heat pipe causing the mandrel with integral heat pipe to become uniform in temperature.

In a specific example, the mandrel with integral heat pipe is stationary during the heating by the induction coil.

In one specific example, to effect curing, the mandrel with integral heat pipe is rotated longitudinally about its axis during the heating by the induction coil. As will be appreciated by the skilled worker, the rate(s) of rotation of the mandrel with integral heat pipe will be determined, in part, by the nature, chemistry and/or composition of the resin within the filament/resin matrix and/or the variable viscosity of the term of the reaction.

In another example, the mandrel with integral heat pipe with the uncured filament/resin matrix fully wound is heated internally by the induction coil and/or placed into an oven set at a temperature to optimally cure the resin.

When in the oven, the mandrel with integral heat pipe is heated by the energy in the oven heating the exposed surfaces of the mandrel. The localized input of this energy on to the mandrel surface is distributed rapidly throughout the mandrel by the phase change action associated with the heat pipe or thermosyphon causing the mandrel with integral heat pipe to be heated uniformly during the cure process just as the outer surface of the uncured filament resin matrix is heated by the energy in the oven.

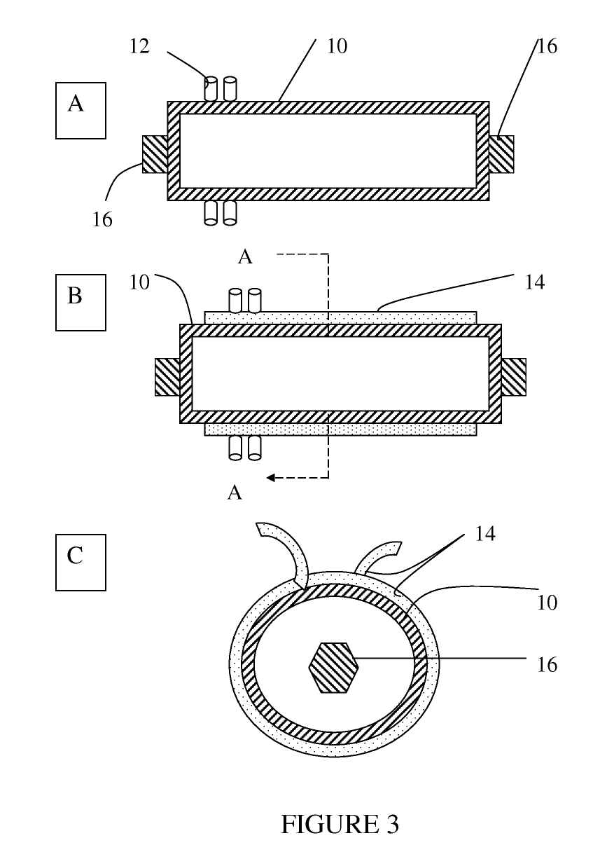

FIG. 3 depicts a mandrel configured with a heat pipe or thermosyphon 10, being heated with water cooled copper tube induction coil 12 and adapted for attachment to a winding machine using chucks 16. Panel A depicts cross section of an example in which induction coil 12 is heating mandrel with integral heat pipe 10. Panel B depicts a cross section of an example in which induction heating coil 12 is heating mandrel with integral heat pipe 10 which also includes uncured filament 14 around the outer surface of mandrel with integral heat pipe 10. In the example of Panel B, filament 14 is substantially refractory to the energy from induction coil 12 heating and is therefore unaffected directly by the energy being induced into the steel mandrel with integral heat pipe beneath it. As the steel mandrel with integral heat pipe 10 is heated, the energy is redistributed rapidly and uniformly throughout the entire volume of the mandrel with integral heat pipe 10, and therefore the entire outer surface of the mandrel. The heat energy from mandrel with integral heat pipe 10 effects curing of the uncured epoxy impregnated filament. Panel C is a cross-sectional view taken along A-A, shown in Panel B.

The application of the filament on the surface of the mandrel with integral heat pipe can be positioned so as to leave an exposed portion of the mandrel surface available to the induction coil, if desired. Alternatively, the surface of the mandrel with integral heat pipe may be covered by the winding of filament, permitting the induction coil to be positioned anywhere along the outer surface of the mandrel with integral heat pipe.

In another example, with use of an induction coil, the uncured resin fiber matrix on the mandrel with integral heat pipe is cured on both the inner surface and out surface of the work piece, at the same time. By heating the work piece on both the outer surface and inner surface, the cure rate decreases significantly and the resin closest to the mandrel liquefies to low viscosity and therefore permeates the fibre assuring full wet out. The inner surface of the fibre resin matrix is then a resin rich and smooth surface.

In a specific example, heat is applied to both the outer surface of the mandrel with integral heat pipe and the outer surface of the uncured filamentous material using a heat source. In one example, the heat source is a bank of infra red heating elements, either gas fired or electrically driven, formed on a concave reflector and radiating energy on to the both the outer surface of the uncured filamentous material and the outer surface of the mandrel with integral heat pipe.

In another specific example, heat is applied to the outer surface of the mandrel with integral heat pipe using an induction coil.

In another example, a mandrel with thermosyphon is 3 inch OD×64 inch long with a 0.375 inch wall, charged with fluid and rotated at about 10 to 15 RPM, and functioned with near isothermal conditions when heated by an induction coil.

In another embodiment, in the case of filament winding large tube sections or structures, it is desirable to construct a mandrel with integral heat pipe with sections that can be handled, and can be assembled into one mandrel with integral heat pipe assembly over which filament will be wound. For example, in the case of winding of large diameter (e.g., 3 meter) by 6 to 10 meter long exhaust stack or storage tank sections.

In this instance the mandrel with integral heat pipe would be formed as a wedge shape cross section having a working surface that would be radiused such that when all wedge sections were assembled around a central core, the assembly would become a single mandrel 3 meters in diameter and 6 to 10 meters long. It will be appreciated that the diameter and length are for example only, and that other combinations are possible.

The number of wedge shaped segments would be variable from application to application but their total number would be such that they would create a 360 degree cross section when assembled. Each wedge shaped section would be a pressure vessel in itself having been processed into a heat pipe or thermosyphon. The assembly could be heated in an oven with the ambient heat within the oven heating the exposed surfaces of each wedge section heatpipe or the assembly could be heated with induction in which case the individual sections would be heated by an induction coil of 360 degree circumference or by a C shaped induction coil. The mandrel assembly composed of wedge section with integral heatpipes could be oriented either horizontally or vertically for both winding and curing

Additionally, as appreciated by the skilled worker, it is well known in the filament winding processing industry that pipe “Tees” and Elbows are fabricated by filament winding. In an alternate example, an assembly consisting of two or three mandrels with integral heat pipe can be constructed such that they are fixed together by threaded male and female threads to form a mandrel assembly on which to wind the elbow or Tee. Each of these mandrel segments would be a mandrel section with integral heatpipe. The sections would be removed from the I.D. of the fitting after winding and curing by unthreading the different mandrel sections from each other. The mandrel sections with integral heat pipe would be heated either by an induction coil in proximity to the out side of the wound fitting at that point which is the intersection of all of the mandrel sections thereby heating all sections at the same time.

Further, the mandrel sections would be designed and fabricated with sufficient exposed surfaces to allow for transfer of heat resident in a convection cure oven into the mandrel with integral heatpipe so as to adequately provide heat to the whole mandrel assembly to affect an optimal cure time and temperature uniformity on the I.D. surfaces of the wound product or structure.

Typical control systems, charging methods, over temperature safety vents etc as discussed throughout would be used to control the temperatures.

In another embodiment, a mandrel with integral heat pipe is used in a pultrusion process where continuous filaments are wetted with thermosetting resin and drawn along the surface of the mandrel with integral heat pipe.

In one example, a mandrel with integral heat pipe remains stationary and is heated with an induction coil and used as the mandrel for a pultrusion process where continuous filaments are wetted with thermosetting resin and drawn along the surface of the mandrel. In this process, the filaments and resin are cured by the heat generated by the induction power supply and transferred to the outer surface of the mandrel with integral heat pipe, and distributed uniformly by the characteristics of the heat pipe.

In this example, the mandrel with integral heat pipe is stationary and can produce hollow sections. Alternatively, the mandrel with integral heat pipe can assume an outer diameter relationship with the filament/resin matrix with one or a number of mandrels with integral heat pipe, forming a cross sectional void that can be any continuous profile in which the filament/resin would be drawn and cured.

The filament and resin wound or woven on the stationary mandrel with integral heat pipe are cured by applying heat to the outer surface of the mandrel with integral heatpipe. In one example, heat is applied by induction, for example a heat induction coil. The cured hollow section thus produced is drawn over the stationary mandrel with integral heat pipe either through a pulling device, such as a cable and winch, or through a set of caterpillar type tracks on which concave cleats are mounted which grip the outer diameter of the cured section and continuously draw the section forward, thus producing a continuous hollow tube or pipe section.

In another embodiment, a mandrel with integral heat pipe has a changeable thermal break along the length of the mandrel with integral heat pipe, comprising laminations of materials of different thermal resistance values within the mandrel wall resulting in a reduced but predictable linear or nonlinear lowering or profiling of heat transfer along its length. The introduction of a predictable increasing or decreasing thermal break along a portion of the outer diameter of the mandrel with integral heat pipe results in a predictable thermal output to the outer diameter of the mandrel surface. This thermal “wedge” or profile is beneficial in reducing the rate of cure in stationary or rotating mandrel with integral heat pipe as materials are drawn along or woven or wound and exposed to the surface of the mandrel.

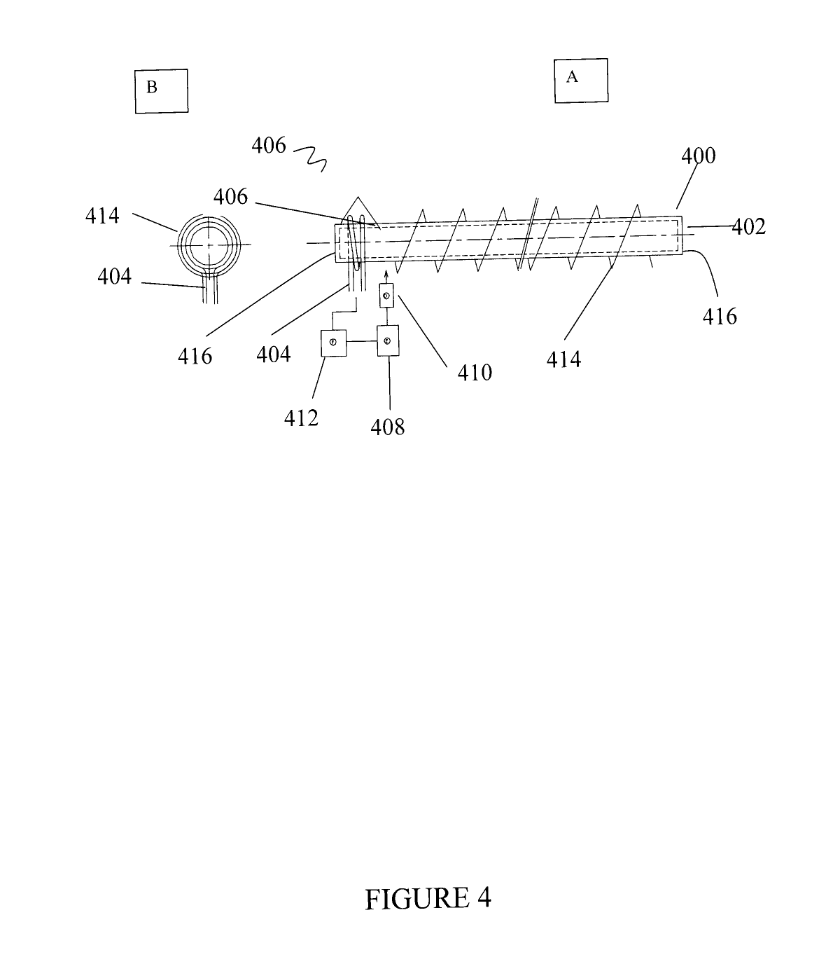

FIG. 4 depicts another embodiment of the present invention. In this embodiment, an extruder is manufactured or fabricated to an extruder screw with integral heat pipe. In this embodiment, the extruder screw comprises a tubular member comprising a heat pipe, first and second ends configured to rotation means, and a helical flight disposed along the length of the outer surface of the tubular member. In the specific example depicted in FIG. 4, the extruder screw with integral heat pipe is an Archimedes screw with integral heat pipe or Archimedes screw with integral thermosyphon (both referred to as an Archimedes screw with integral heat pipe).

In FIG. 4, Panel A, Archimedes screw 400 having a tubular member having hollow center drive shaft 402 is Archimedes screw with integral heatpipe or thermosyphon 406. Ends 416 are configured for attachment to rotation means (not shown). Archimedes screw with integral heat pipe 406 is heated with heat source 404, which in this example is a heat induction coil, as described above. Infrared sensor 410 is positioned adjacent to tubular member 402 is Archimedes screw with integral heatpipe 406 to monitor the temperature of the outer surface of Archimedes screw with integral heat pipe 406. Process control 408 is operatively associated with process control 408 and induction power supply 412. Induction power supply 412 is operatively associated with process control 408 and heat source 404. In this example, infrared sensor 410 monitors the temperature of the outer surface of Archimedes screw with integral heat pipe 406 to provided feedback to process sensor 408, which can adjust induction power supply 412. Induction power supply 412 will raise, lower or maintain the output of heat source 404. Thus, infra red sensor 410 is operatively associated with process controller 408 which adjusts the output power of induction power supply 412 thus providing discrete temperature control throughout the cure sequence.

FIG. 4, Panel B, is a cross-section view of Archimedes screw with integral heat pipe 406 depicting heat source 404 and helical flights or thread 414.

It will be appreciated that in addition to an Archimedes screw, alternative screw types can be manufactured as described herein.

In one example in use, an Archimedes screw with integral heat pipe is used in a thermoplastic extrusion process. In this instance, the Archimedes screw with integral heat pipe acts as an extruder of thermoplastic material and is heated by the induction coil so as to melt the thermoplastic resin and become plastic as it is fed into the extrusion barrel.

In this process, the thermal properties of the heat pipe or thermosypon within the Archimedes screw with integral heat pipe, which places thermal energy on those surfaces of the heatpipe where a deficit of thermal energy in present (i.e., a heat sink), results in providing thermal energy to the location along the Archimedes screw with integral heat pipe where that energy is required.

In one example there is provided a method of extruding a thermoplastic feed stock, comprising the steps of: providing an extruder with integral heatpipe comprising an input end and an output end; introducing said thermoplastic feed stock to said input end; heating a portion of the outer surface of said extruder with integral heat pipe such that said feedstock is plastic and homogeneous; and conveying said plastic feedstock from said input end to said output end; and providing said plastic feedstock to output means.

Examples of feed stock include, but are not limited to polyvinylchloride, polypropylene, polycarbonate, rubber, wax, paraffin, other polymer formulated for the extrusion process, with filler or reinforcement materials.

For instance, plastic pellets are initially added to an input end of the Archimedes screw with integral heat pipe. Heat is applied to a portion of the Archimedes screw with integral heat pipe, which results in heating the entire outer surface of the Archimedes screw with integral heat pipe. The heat applied to the plastic pellets results in their melting and mixing so as to become plastic and homogeneous, thereby facilitating their conveyance along the length of the Archimedes screw with integral heat pipe.

In another example, in certain circumstances, as the extruder is rotated, an exothermic condition due to the frictional energy is created by the feedstock throughput. In such situation the extruder may be cooled by an external water jacket, rather than by applying heat with an induction coil.

In another example, in use, the Archimedes screw with integral heat pipe utilized in a conveyor process, to transport material, such as granular material. In the case of granular material which may be hydroscopic at room temperature, such material “pill” due to water absorbsion. An Archimedes screw with integral heat pipe functions as a conveyor operable to maintain the temperature of the outer surface of the Archimedes screw with integral heat pipe through induction heating above the boiling point of water to prevent water absorption

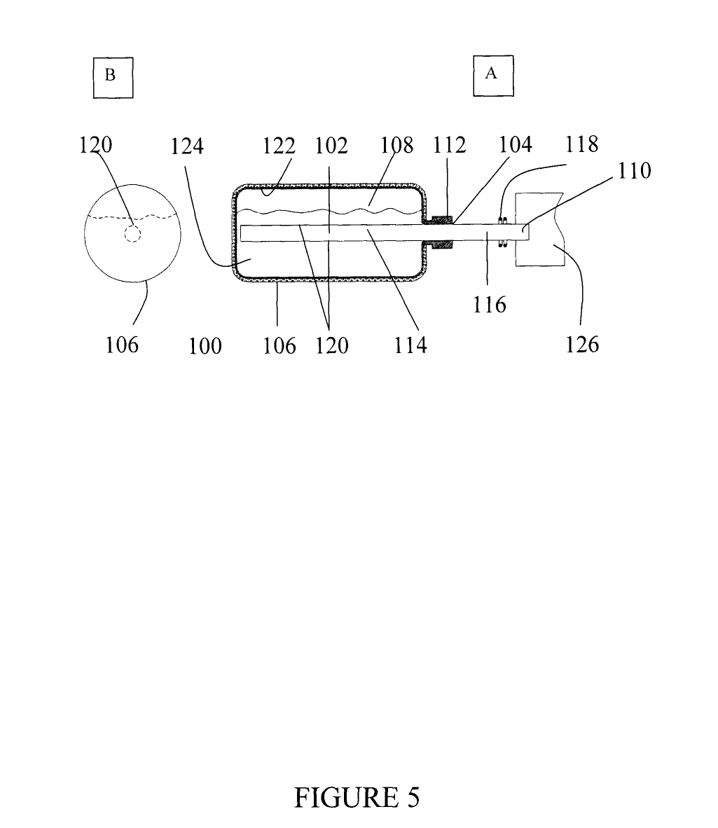

FIG. 5 depicts another embodiment of the present invention, in which a mandrel with integral heat pipe is used in the manufacture of composite pressure vessels.

A composite pressure vessel is a pressure vessel whose structure is of composite material, and is well known to the skilled worker. In one example, a composite pressure vessel is a filament-wound structure.

Composite pressure vessels are often used for storing various liquid(s) or gaseous media, such as compressed or liquefied gases, liquids, propellants, and the like, for extended periods of time and often at high pressure(s). For example, composite pressure vessels are used to store nitrogen gas, hydrogen gas, propane gas, natural gas, oxygen, air, water and the like.

Composite pressure vessels are used in a wide range of applications including, but not limited to, air suspension reservoirs, pneumatic brake reservoirs, air propulsion reservoirs, nitrogen gas storage vessels, propane gas storage vessels, natural gas storage vessels, air storage tanks, water storage vessels, components of fuel cells, fuel tanks, components of space craft, and the like.

Composite vessels are manufactured to accommodate the medium and/or pressurized medium without suffering leakage losses or structural damage. As such, composite pressure vessels are made from a variety of materials, including, but not limited to, graphite, aramid, or fiber glass, carbon fiber, Kevlar, synthetic plastic material fibers, and the like, and of materials such as epoxy resins, capable of forming a matrix embedding such filaments/materials and bonding them together in a composite material.

Typically, a composite vessel comprises an inner liner (such as a metal liner), optionally coated with a primer, and an overwrap or jacket. The overwrap or outer jacket is constructed by superimposed and overlapping layers of resin impregnated filamentary materials, wrapper around the liner, with the interstices between the fibers or filament being filled by impregnating material such as hardenable epoxy resin that, upon setting and hardening, forms a matrix that firmly embeds such fibers or filamentary material.

After hardening, the filamentary and impregnating material together form a composite, fiber reinforced, solid body capable of withstanding the forces applied to the vessel. The selection of the materials in the manufacture of the composite pressure vessel will vary according to the needs and preferences of the intended use. Additionally, selection of the specific components used may be based on various additional criteria, including for example, but not limited to, cost, availability, downstream application, and safety.

Typically, a composite pressure vessel is formed using a thin walled aluminum vessel (i.e., the liner) of a shape and size to satisfy the inner diameter (I.D.) of the desired pressure vessel. One end of the thin walled aluminum vessel includes a threaded opening that is finished machined to accommodate the intended needs/use of the vessel.

The thin walled aluminum vessel is releaseably attachable to a first end of a support by threading the aluminum liner vessel on to the end of the support. The thin walled aluminum liner vessel attached to the end of the mandrel is then placed on a filament winding machine.

Carbon fiber and/or other fiber(s) having the required tension strength capability, is wound in various layers over the aluminum vessel to provide a matrix that will allow the vessel to withstand the high pressure of its intended use. The carbon fiber and/or other fiber(s) is saturated with a resin in its uncured state. The resin fiber matrix when wound on the substrate aluminum vessel is then cured thermally, usually in an oven at elevated temperature.

In pervious methods, the aluminum vessel is not directly heated while in the oven, and is in fact insulated by the covering of the fiber resin matrix. During this traditional heating process, the aluminum vessel is the last surface to achieve cure temperature. Such heating of the composite pressure vessel from the outer surface of the work piece to the inner surface can cause incomplete cure at the aluminum skin resin fiber interface. This lack of cure can result in failure in the vessel in use.

As shown in FIG. 5, second end 100 of mandrel with integral heat pipe 102 is inserted through open end 104 of liner 106. In this example, liner 106 is an aluminum vessel. Second end 100 extends into interior volume 108 of liner 106. First end 110 of mandrel with integral heatpipe/thermosyphon 102 comprises securing means 112, adapted to releasably attach open end 104 of liner 106. In a specific example, securing means 112 is a threaded member, configured for releasable threaded attachment to threaded open end 104 of liner 106. Securing means 112 are selected to withstand the temperature(s) and/or pressure(s) and/or operating conditions employed in the manufacturing process.

In this example, first portion 114 of mandrel with integral heat pipe 102 is located within interior volume 108 of liner 106 and second portion 116 of mandrel with integral heat pipe 102 is located exterior to liner 106.

Heat source 118 is used to heat second portion 116 of mandrel with integral heat pipe. In a specific example, heat source 118 is an induction coil. Since mandrel with integral heat pipe 102 is thermally superconductive, energy from an induction coil applied to the exterior surface of mandrel with integral heat pipe 102 induces energy distribution along the surface of mandrel with integral heat pipe 102, which is in turn transferred throughout the complete mandrel with integral heat pipe. Thus, heating second portion 116 results in the heating of first portion 114, which is within interior volume 108 of liner 106.

In the example of FIG. 5, there is a gap or void between outer surface 120 of mandrel with integral heat pipe 102 within inner volume 108 of aluminum vessel 106 and inner surface 122 of aluminum vessel 106. In a specific example, heat conductive fluid 124 is also added to interior volume 108 of aluminum vessel 106, thereby forming a fluid layer between outer surface 120 of mandrel with integral heat pipe 102 and inner surface 122 of aluminum vessel 106. In use, heat conductive fluid 124 maintains outer surface 120 of mandrel with integral heat pipe 102 and inner surface 122 of aluminum vessel 106 in heat transfer relation. Thus, mandrel with integral heat pipe 102 is in heat transfer relation with inner surface 122 of the aluminum vessel.

It will be appreciated that the heat conductive capacity of the conductive fluid 124 will vary with intended use an application. In one example, suitable heat conductive fluids include silicon, synthetic, natural hydrocarbon oils, DowTherm A, and the like. Optionally, additional high thermal conductive particles are added to the heat conductive fluid to increase the heat conductivity. Such thermal conductive particles include, but not limited to boron nitrides, aluminum, iron, silver, and the like.

It will be appreciated that reference to heat conductive fluid(s) will also include gels and liquids as well as gasses.

In a specific example, heat conductive fluid 124 is water. In use, interior volume 108 of liner 106 is supplied with water. Second end 100 of mandrel with integral heat pipe 102 is inserted through opening 104 of liner 106. Securing means 112 attach aluminum vessel 106 to first end 116 of mandrel with integral heat pipe 102. Aluminum vessel 106 and mandrel with integral heat pipe 102 are then place on filament winding machine 126.

In an alternate example not shown, outer surface 120 of mandrel with integral heat pipe 102 within inner volume 108 of liner 106 is substantially in contact with inner surface 122 of liner 106. Thus, in this example, mandrel with integral heat pipe 102 is in heat transfer relation with inner surface 122 of the aluminum vessel.

Heat source 118 is operable to heat first portion 116 of mandrel with integral heat pipe 102 during filament winding.

In one example, heat source 118 is an induction coil and mandrel with integral heat pipe 102 is rotated during filament winding and heating. In one example, mandrel with integral heat pipe is rotated during filament winding and heating. In this example, the curing process begins during the winding segment of the process.

In another example, filament winding is initiated after a preheating of liner 106 to a desired temperature. Such selection of the desired temperature(s) is dependent on the chemistry of the polymer used and the thermal demands of that polymer in its cure stage.

In one example, a typical cure temperature of about 350 F is used for epoxy based resins. Also typically, the effecting cure is initiated after winding of the filament is complete. It will be appreciated that the rate of rotation of the vessel and mandrel with integral heat pipe (e.g., the RPM value) and the filament resin matrix during the cure sequence is such that the resin remains homogeneously distributed within the filament winding. When left stationary, the resin will tend to migrate to and favour the lowest area of the surface resulting in uneven application of the resin to the filament.

As noted above, in FIG. 5, heat conductive fluid 124 within liner 106 is heated by mandrel with integral heat pipe 102 which is contacting it. Securing means 112 maintains interior volume 108 of liner 106 water and pressure tight, under the conditions used. Heat conductive fluid 124 within aluminum vessel 106 conducts/convects heat from mandrel with integral heat pipe 102 to interior surface 122 of liner 106, to the temperature selected to cure the resin. The turbulence of heat conductive fluid 124 within liner 106 caused by the rotation of liner 106 ensures interior surface 122 of liner 106 is coated with heated heat conductive fluid 124, thereby providing a uniform temperature to interior surface 122 of liner 106.

As the skilled worker will appreciate, resin migrates to a heated surface. Thus, in this example, during heating, resin migrates to the liner surface, thereby providing a resin rich surface.

It will also be appreciated that a variety of heat sources are used. Selection of the heat source will vary according to the needs and preferences of the intended use. Additionally, selection of the specific heat sources used may be based on various additional criteria, including for example, but not limited to, cost, availability, downstream application, and safety.

In one example, heat source 118 is a gas flame or a radiant heater. The heat produced radiates on the first portion 116. Alternatively, the mandrel with integral heat pipe is heated using an electric heater mounted directly on the exposed surface of the mandrel with integral heat pipe 102, and powered electrically via a slip ring assembly which permits rotation of mandrel with integral heat pipe 102 and the heater.

In one example, the energy provided by the induction coil is sufficient to cause the composite vessel to cure completely from the inside of the work piece.

In another example, the induction coil is used together with oven curing, in which both the outer surface of the vessel and the interface surface of the vessel are both heated and cured.

In an alternate example, after being removed from the oven, the first end 116 of the mandrel with integral heat pipe can be cooled. This will serve to draw heat away from the pipe segment and promote a faster cool down cycle.

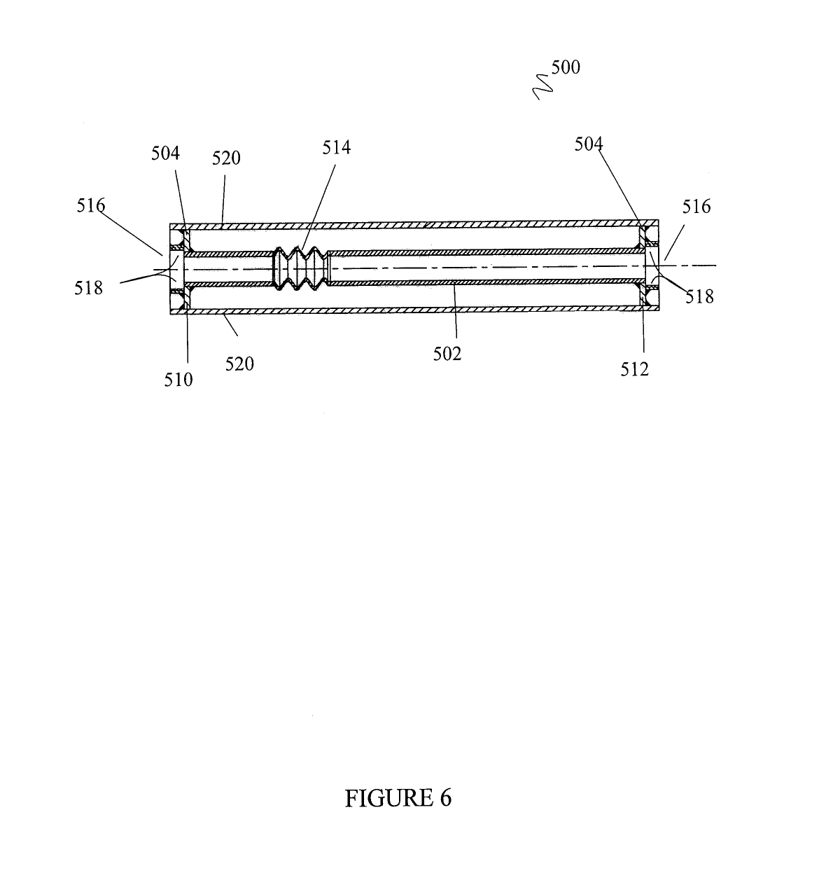

FIG. 6 depicts a cross section of another embodiment of the present invention, in which mandrel with integral heat pipe 500 is configured such that tubular member 502 is disposed within the inner volume of tubular member 502, and runs through mandrel with integral heat pipe 500. For example, tubular member 502 runs through mandrel with integral heat pipe 500. Tubular member can, for example, be a tube or pipe. Tubular member 502 comprises fluid inlet 510 and fluid outlet 512 fixedly attached to end caps 504, and expansion means 514 positioned between fluid inlet 510 and fluid outlet 512.

Tubular member 502 defines a passage running therethrough, maintaining fluid inlet 510 and fluid outlet 512 in fluid communication.

In one example, expansion means 514 comprises a welded bellows expansion section.

End caps 504 maintain the evacuated vapour space of the heat pipe within the mandrel with integral heat pipe 500. End caps 504 further comprise coupling means 516 configured to removably attach input and output means (not shown).

In one example, coupling means 516 comprises thread portion and rotating union 518, configured to matingly receive a correspondingly threaded input and output means. In one example, the input and output means are a threaded hose.

In one example, the input means provide a cooling fluid to fluid inlet 502 and output means permit the input cooling fluid to be removed from tubular member 502 through fluid outlet 512. In a specific example, the cooling fluid is water.

In use, mandrel with integral heat pipe 500 is rotated about its longitudinal axis and an uncured filamentary material is applied to outer surface 520. After winding, curing is effected by heating the uncured filamentary material. After the cure cycle is complete, a cooling fluid, such as water, is pumped through fluid inlet 504 through tubing threaded on to threaded portion 518. Water passing though tubular member 502 and exits at fluid outlet 512 The input water is at a lower temperature than that of the inner surface of tubular member 502. As water is pumped through one end of mandrel with integral heat pipe 500, the low temperature surface of the inner surface of tubular member 502 results in condensation vapour being generated within the heat pipe portion of mandreal with integral heat pipe 500. The process causes two phase heat transfer which takes energy from the outer surface of mandrel with integral heat pipe 500 and transfers it to the water or cooling fluid running through tubular member 502, thereby cooling the outer surface of the mandrel with integral heat pipe 500 and cooling the inner surface of the work piece produced.

In use, there can be a significant difference in the temperature of tubular 502 and the remainder of mandrel with integral heat pipe 500. The difference in temperature can result in a change in length of tubular member 502, which will become more marked over length. Expansion means allows for expansion and contraction during these differences in temperature, reducing the potential weld failure due to tension and compression loads on pipe 502 and welds.

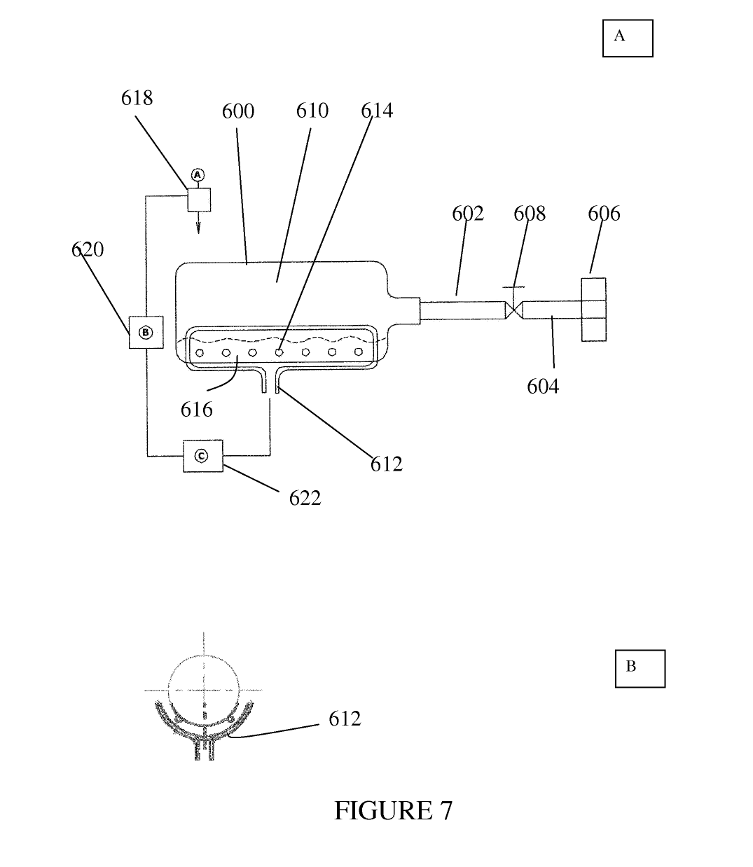

FIG. 7 depicts another embodiment of the present invention, in which a composite vessel is produced by winding an epoxy impregnated filamentary material around a non-metallic liner. The method provides for curing of the filament/resin matrix from the inner surface of the filament wound work piece.

In FIG. 7, liner 600 is a non-metallic vessel. It will be appreciated that liner 600 can be made from various materials and polymers. In one example, liner 600 is plastic. In another example liner 600 is thermoplastic plastic, thermoset plastic. In one example, liner 600 is made from glass or ceramic. Liner 600 is threadingly attached through threaded opening 602 to hollow support member 604, which acts as an extension that can be held on rotating chuck 606 of a filament winding machine (not shown).

Support member 604 permits liner 600 to be rotated longitudinally about its axis as uncured epoxy impregnated filamentary material is applied and wound around the outer surface of liner 600.

Ball valve 608 on support member 604 permits heat conductive fluid 616 and metallic material 614 to be added to inner volume 610 of liner 600. In one example, the heat conductive fluid is water, and the metallic material comprises ball bearings.

Heat induction coil 612 is placed adjacent to liner 600.

Heat induction coil 612 can be activated either during application of uncured filamentary material or subsequent to application, in order to provide energy to metallic material 614.

When heat induction coil 612 is activated, energy is provided to metallic material 614 and is heated. Heating of metallic material 614 causes water 616 within inner volume 610 to be heated and produce steam. The steam produced drives the air out of inner volume 610 and replaces it with steam. Ball valve 608 is then closed, causing the steam to operate in a closed pressure capable environment. The pressure and temperature increase within liner 600, and steam distributes throughout inner volume 610, thereby causing an isothermal condition to occur. The energy applied to metallic material 614 is controlled through the use infra red sensor 618 connected to process controller 620 which adjusts the output power of induction power supply 622, thus providing discrete temperature control throughout the cure sequence.

It will be appreciated from the foregoing that the method of this embodiment creates a type of thermosyphon that is vented and recharged after each cure sequence. The water is vented or poured out of the shell after the cure is complete and the temperature is lowered to below about 100° C. The ball bearings are poured out and reinstalled as required.

In another embodiment of the present invention (not shown), a composite vessel is produced by winding an epoxy impregnated filamentary material around a metallic liner. The method provides for curing of the filament/resin matrix from the inner surface of the filament wound work piece.

This embodiment is similar is some aspects that described in FIG. 7. In this example, a metallic liner 600 is threadingly attached through threaded opening on a hollow support member, which acts as an extension that can be held on rotating chuck of a filament winding machine not shown. In one example, the metallic liner is an aluminum liner.

The support member permits the liner to be rotated longitudinally about its axis as uncured epoxy impregnated filamentary material is applied and wound around the outer surface of the liner.

A ball valve on the support member permits a heat conductive fluid to be added to the inner volume of the liner. In one example, the conductive fluid is water.

A heat induction coil is placed adjacent to the liner.

The heat induction coil can be activated either during application of uncured filamentary material or subsequent to application, in order to provide energy to the out surface of the metallic liner.

When the heat induction coil is activated, energy is provided to the outer surface of the metallic liner. Heating of metallic liner causes water within the inner volume of the liner to be heated and produce steam. The steam produced drives the air out of the inner volume and replaces it with steam. The ball valve is then closed, causing the steam to operate in a closed pressure capable environment. The pressure and temperature increase within the liner, and steam distributes throughout the inner volume, thereby causing an isothermal condition to occur. The energy applied to the metallic liner is controlled through the use of an infra red sensor which monitors the temperature of the interior of the vessel through the hollow attachment member at that point between the vessel and the ball valve, which is part of the thermosyphon created by the vessel and the hollow member, and closed by the ball valve. The sensor is connected to a process controller which adjusts the output power of the induction power supply, thus providing discrete temperature control throughout the cure sequence.

In another embodiment of the present invention (not shown), a composite vessel is produced by winding an epoxy impregnated filamentary material around a metallic or non-metallic liner. The method provides for curing of the filament/resin matrix from the inner surface of the filament wound work piece.

This embodiment is similar is some aspects that described in FIG. 7. In this example, a metallic or non-metallic liner is threadingly attached through threaded opening to a mandrel with integral heatpipe which is of a size such that a portion of its length is located within the interior volume of the liner. In one example, the portion of the mandrel with integral heat pipe length located within the interior volume of the vessel is equal to about half the interior depth of the liner. The mandrel with integral heatpipe acts as an extension that can be held on rotating chuck of a filament winding machine not shown.

In one example the liner comprises plastic, including but not limited to, thermoplastic, thermoset plastic and the like. In another example, the liner comprises metal, aluminium, copper, nickel, stainless steel, core materials used in ferris and non-ferris casting process such as foundry sand, and the like. In another example, the liner comprises glass, ceramic, fired clay, pottery, nonplastic composite materials, and the like.

The mandrel with integral heatpipe permits the liner to be rotated longitudinally about its axis as uncured epoxy impregnated filamentary material is applied and wound around the outer surface of the liner.

A metallic material is added to the interior volume of the liner in a volume sufficient to be in contact with the mandrel with integral heatpipe while the vessel is being rotated. A variety of metallic materials may be used, including, but not limited to, microspheres or nano particles of copper, nickel, steel, aluminum and the like, as would be appreciated by the skilled worker. The metallic materials can be a variety of sizes, including granular size and/or nano particles. In use, the metallic material maintains the outer surface of the mandrel with integral heat pipe and the inner surface of the line in heat transfer relation.

A heat induction coil is placed adjacent to the liner or the outer surface of the mandrel with integral heat pipe. In a specific example, the heat induction coil is placed adjacent and below the liner.

The heat induction coil can be activated either during application of uncured filamentary material or subsequent to application, in order to provide energy to the metallic material within the inner volume of the liner.

In use, as the liner is rotated, the metallic material is in heat transfer relation with the surface of the liner. When heated, the metallic material transfers heat directly to the surface of the liner.

Additionally, in some examples, such as with certain alloys, heating the metallic material causes the metallic material to melt and become liquid.

The energy applied to the metallic liner is controlled through the use of a temperature sensor, such as an infra red sensor, which monitors the temperature of the metallic material within the interior of the vessel accurately and in real time by monitoring the temperature of the exposed section of the mandrel with integral heatpipe which section is in proximity to the chuck. The sensor is connected to a process controller which adjusts the output power of the induction power supply, thus providing discrete temperature control throughout the cure sequence.

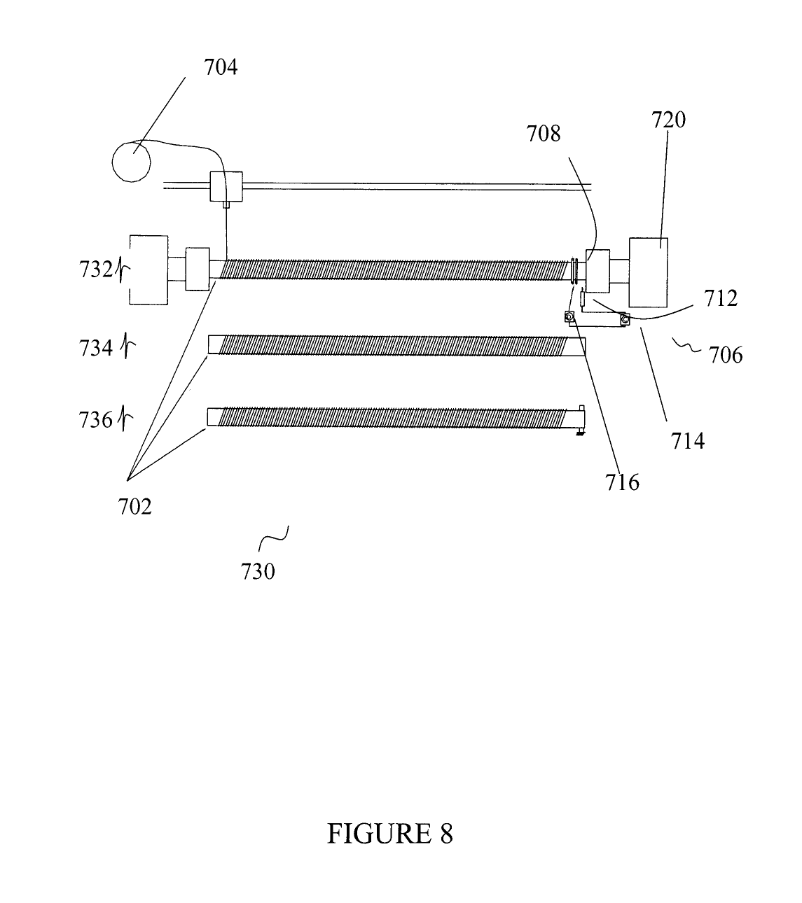

FIG. 8 depicts an additional embodiment in which a composite drill and/or process pipe is produced using a mandrel with integral heat pipe.

Typically drill pipe is manufactured from steel and produced in plants remote from oil drilling sites. Distance of the production plant with respect to the drilling sites causes logistical issues, which add cost and inconvenience to the delivery of the pipe on site. Further, such a typical steel drill pipe is heavy, and so more difficult to move

Composite pipe can be used in oil drilling and other processes at remote drill sites, or remote processing sites such as the oil sands and other mining applications. Composite pipe is substantially lighter than steel pipe. Composite pipe has other advantages over steel pipe in terms of corrosion and wear as well as simplified support structures. However, there is a coincident increase in cost per linear foot of composite pipe over steel pipe, if both produces require transport.

If composite pipe can be fabricated from reels of fiberglass filament and drums of epoxy resin by a manufacturing cell or assembly located close the drilling site, or on site, then the cost of shipping completed pipe sections is greatly reduced or eliminated.

In the example of FIG. 8, mandrel with integral heat pipe 702 is attached to winding machine 720 operable to rotate mandrel with integral heat pipe 702 lonitudinally about its axis during application of uncured filamentary material 704.

During the winding sequence, uncured filamentary material 704 is applied mandrel with integral heat pipe 702 and is heated continuously through heat induction unit 706.

Induction coil 708 and power supply 710 are coupled to infrared sensor 712 which monitors the rotating mandrel with integral heat pipe 702, and provides a control signal to process controller 714 which in turn drives the output of power supply 716.

In this example, mandrel with integral heat pipe 702 achieves and maintains a discrete selectable process temperature which is isothermal with respect to the outer surface of the mandrel with integral heat pipe 702 throughout the winding process. Thus, the resin is effectively cured as it is being applied. This results in a filament/epoxy matrix pipe section being cured in the order of minutes rather than hours. Furthermore, no oven is required.

This method is well suited to on-site manufacturing of composite pipe.

Also depicted in FIG. 8 is a carrousel mechanism generally indicated by reference numeral 730. Carrousel mechanism 730 comprises a filament winding position described above, a cooling position and an extraction position.

Following filament winding and curing, mandrel with integral heat pipe 702 which has a wound pipe section on its outer surface, can be automatically indexed out of winding machine 720 to a cooling position, generally indicated by numeral 734. In this position, mandrel with integral heat pipe 702 and the wound pipe section cool from the process curing temperature to a temperature that permits removal of the pipe section from mandrel with integral heat pipe 702.

Once cooled, mandrel with integral heat pipe 702 is moved to an extraction position, generally indicated by numeral 736. In extraction position 736, the pipe section produced is removed from mandrel with integral heat pipe 702 through the use of a hydraulic ram (not shown) pulling the pipe section from mandrel with integral heat pipe 702 using a sized collar attached to the hydraulic cylinder while mandrel with integral heat pipe 702 is held stationary.

In another example, following extraction of the pipe section, mandrel with integral heat pipe 702 is moved to a standby position (not shown).

In yet another example, following positioning in the standby position, mandrel with integral heat pipe 702 is positioned on winding machine 720, thereby permitting a new composite pipe to be wound.

Thus, there is provided a revolving carrousel system which permits positioning and movement of mandrel with integral heat pipe 702, in a winding position, a cooling position, and an extraction position. In another example there is provided a revolving carrousel system which permits positioning and movement of mandrel with integral heat pipe 702, in a winding position, a cooling position, an extraction position and a standby position.

The carousel system is readily transported by a variety of means, including by truck, barge, helicopter etc, to a job site where it would be powered by a generator and begin making composite pipe for that specific requirement such as drill or process pipe for an oil or gas drilling site, water pipe and/or sewage pipe for a construction site etc.

In one example, the carousel system is configured to be skid or rail mounted for use as a transportable “on site” stand alone system for operation at a job site.

The above-described embodiments of the present invention are intended to be examples only. Alterations, modifications and variations may be effected to the particular embodiments by those of skill in the art without departing from the scope of the invention, which is defined solely by the claims appended hereto.

1. A method of making a composite article using a resin-impregnated filamentary material, comprising the steps of:
providing a mandrel with integral heat pipe;
applying said uncured composite material to the outer surface of said mandrel; and
curing said resin-impregnated filamentary material applied to said mandrel so as to form said article,
wherein said curing comprises selective heating a predetermined portion of the outer surface of said mandrel with integral heat pipe.

2. The method of claim 1, wherein said mandrel with integral heat pipe comprises a heat pipe or a thermosyphon.

3. The method of claim 1, wherein applying said uncured composite material comprises rotating said mandrel about an axis of said mandrel while applying said filamentary material around the outer surface of said mandrel.

4. The method of claim 3 wherein said axis is a longitudinal axis.

5. The method of claim 1, wherein said curing further comprises heating the outer surface of said uncured article.

6. The method of claim 1, wherein heating said portion of said outer surface of said mandrel with integral heat pipe occurs subsequent to applying said uncured composite materials to said outer surface.

7. The method of claim 1, wherein heating said portion of said outer surface of said mandrel with integral heat pipe occurs concurrently with applying said uncured composite materials to said outer surface.

8. The method of claim 1, wherein heating said portion of said outer surface of said mandrel with integral heat pipe and heating of said outer surface of said uncured work piece is effected in an oven.

9. The method of claim 1, wherein said heating said outer surface of said mandrel with integral heat pipe is using a heat induction coil.

10. The method of claim 1, further comprising the step of cooling said outer surface of said mandrel with integral heat pipe following curing.

11. The method of claim 10, wherein said cooling is effected by cooling a portion of said outer surface of said mandrel with integral heat pipe.

12. The method of claim 11, wherein said cooling is effected using an internal tubular member, said tubular member disposed within said inner volume of said mandrel with integral heat pipe and comprising a fluid inlet, a flow path, a fluid outlet, and expansion means positioned between said fluid inlet and said fluid outlet, said fluid inlet adapted for connection to a source of liquid, said fluid outlet adapted for connection to an outlet.

13. The method of claim 1, wherein said filamentary material is a thermoplastic resin reinforced filament.

14. The method of claim 1, further comprising monitoring and controlling the temperature of the outer surface of the mandrel with integral heat pipe to maintain a set temperature.

15. The method of claim 14, wherein said monitoring and controlling is effected using a contact temperature sensor or non contact temperature sensor and a control loop operatively associated with an induction power supply and induction coil to maintain a set temperature.

16. The method of claim 15, wherein said temperature sensor is an infrared temperature sensor.

17. A method of making a pressure vessel using a resin-impregnated filamentary material and a metallic liner, comprising:
providing a mandrel with integral heat pipe, said mandrel comprising a first end for removable attachment to a filament winding machine, a second end sized for insertion through an opening of said liner within an inner volume of said liner, and securing means positioned between said first and second end configured for releasable attachment of said opening in said liner to said mandrel with integral heat pipe;
attaching said liner to said mandrel with securing means such that said second end of said mandrel is disposed though said opening of said liner in said inner volume of said liner, the outer surface of said second end of said mandrel being in heat transfer relation with the inner surface of said liner;
applying said uncured filamentary material to said liner by rotating said mandrel about an axis of said mandrel while applying said filamentary material around the outer surface of said liner; and
curing said resin-impregnated filamentary material applied to said mandrel so as to form said pressure vessel,
wherein curing comprises heating a portion of said outer surface of said mandrel with integral heat pipe to transfer heat to the inner surface of said liner.

18.-27. (canceled)

28. A method of making a pressure vessel using a resin-impregnated filamentary material and a non-metallic liner, comprising:
providing a support defining a passage therethrough, said support comprising a first end for removable attachment to a filament winding machine, a second end comprising securing means for removable attachment to an opening on said liner and having a ball valve positioned within said passage at said second end;
attaching said liner to said second end of said support mandrel with said securing means, said passage being in fluid communication with an interior volume of said liner;
providing a heat transfer fluid and a metallic material to said interior volume of said liner, said heat transfer fluid and said metallic material being in heat transfer relation with the inner surface of said liner;
applying said uncured filamentary material to said liner by rotating said mandrel about an axis of said mandrel while applying said filamentary material around the outer surface of said liner; and
curing said resin-impregnated filamentary material so as to form said pressure vessel, wherein said curing comprises heating said metallic material within said interior volume of said liner so as to produce heated metallic material within said heat transfer fluid so as to transfer heat to the inner surface of said liner.

29.-40. (canceled)

41. A method of extruding a thermoplastic feed stock, comprising the steps of:
providing an extruder with integral heatpipe comprising an input end and an output end;
introducing said thermoplastic feed stock to said input end;
selectively heating a predetermined portion of the outer surface of said extruder with integral heat pipe such that said feedstock is plastic and homogeneous;
conveying said plastic feedstock from said input end to said output end; and
providing said plastic feedstock to output means.

42.-47. (canceled)

48. A method of making a composite article using a resin-impregnated filamentary material, comprising the steps of:
providing a mandrel with integral heat pipe in a first position;
applying said uncured composite material to the outer surface of said mandrel;
curing said resin-impregnated filamentary material applied to said mandrel so as to form said article, wherein said curing comprises selectively heating a predetermined portion of said outer surface of said mandrel with integral heat pipe;
cooling said cured resin-impregnated filamentary material on said mandrel with integral heat pipe in a second position; and
removing said cooled cured resin-impregnated filamentary material from said mandrel with integral heat pipe in a third position.

49.-55. (canceled)

56. A mandrel with integral heat pipe, comprising:
a heat pipe or thermosyphon comprising a first end, a second end and end caps attached to said first and second end, said heat pipe defining an inner volume;
a tubular member disposed within said inner volume of said heat pipe, said member comprising a fluid inlet, a flow path, a fluid outlet, and expansion means positioned between said fluid inlet and said fluid outlet, said fluid inlet adapted for connection to a source of liquid, said fluid outlet adapted for connection to an outlet.

57.-60. (canceled)

61. A method of making a vessel using a resin-impregnated filamentary material and a liner, comprising:
providing a mandrel with integral heat pipe, said mandrel comprising a first end for removable attachment to a filament winding machine, a second end sized for insertion through an opening of said liner within an inner volume of said liner, and securing means positioned between said first and second end configured for releasable attachment of said opening in said liner to said mandrel with integral heat pipe;
providing a metallic material to said interior volume of said liner, said metallic material being in heat transfer relation with the inner surface of said liner;
attaching said liner to said mandrel with securing means such that said second end of said mandrel is disposed though said opening of said liner in said inner volume of said liner;
applying said uncured filamentary material to said liner by rotating said mandrel with integral heat pipe about an axis of said mandrel while applying said filamentary material around the outer surface of said liner; and
curing said resin-impregnated filamentary material so as to form said vessel, wherein said curing comprises heating said metallic material within said interior volume of said liner so as to produce heated metallic material so as to transfer heat to the inner surface of said liner.

62.-75. (canceled)

76. An extruder with integral heat pipe, comprising:
a tubular member comprising a heat pipe or thermosyphon,
a first and a second end configured for attachment to rotation means, and
a helical flight disposed along the length of the outer surface of said tubular member, wherein said extruder is configured for selectively heating a predetermined portion of said outer surface of said tubular member.
